(19) United States
(12) Patent Application Publication
(10) Pub. No.: US 2007/0056207 A1
(43) Pub. Date: Mar. 15, 2007

(54) Electric insect trap

(76) Inventor: Chi-Wen Chen, Taipei City (TW)

Correspondence Address: CHRISTIE, PARKER & HALE, LLP, PO BOX 7068, PASADENA, CA, 91109-7068, US

(21) Appl. No.: 11/227,862

(22) Filed: Sep. 14, 2005

(51) Int. Cl. A01M 1/22; A01M 1/04

(52) U.S. Cl. 43/112; 43/113; 43/107

(57) ABSTRACT

An electric insect trap includes a base, an insect attracting unit provided on the base, a high voltage grid unit provided on the base and disposed to surround the insect attracting unit, a detector unit coupled electrically to the high voltage grid unit and operable so as to generate a detector signal corresponding to an insect-electrocuting state of the high voltage grid unit, and an indicator unit coupled electrically to the detector unit and operable so as to indicate number of insects electrocuted by the high voltage grid unit based on the detector signal received from the detector unit.

### BACKGROUND OF THE INVENTION

1. Field of the Invention

The invention relates to an insect trap, more particularly to an electric insect trap that can indicate the number of insects electrocuted thereby.

2. Description of the Related Art

While electric insect traps that can kill flying insects by electrocution are known in the art, the conventional electric insect traps are not designed to provide the user with information related to the insect killing efficiency of the insect trap.

### SUMMARY OF THE INVENTION

Therefore, the object of the present invention is to provide an electric insect trap capable of indicating the number of insects electrocuted thereby.

According to the present invention, an electric insect trap comprises a base, an insect attracting unit provided on the base, a high voltage grid unit provided on the base and disposed to surround the insect attracting unit, a detector unit coupled electrically to the high voltage grid unit and operable so as to generate a detector signal corresponding to an insect-electrocuting state of the high-voltage grid unit, and an indicator unit coupled electrically to the detector unit and operable so as to indicate number of insects electrocuted by the high voltage grid unit based on the detector signal received from the detector unit.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of the preferred embodiment of an electric insect trap according to this invention;

FIG. 2 is a schematic circuit block diagram of the preferred embodiment; and

FIG. 3 is a schematic electrical circuit diagram of the preferred embodiment.

### DETAILED DESCRIPTION OF THE PREFERRED EMBODIMENT

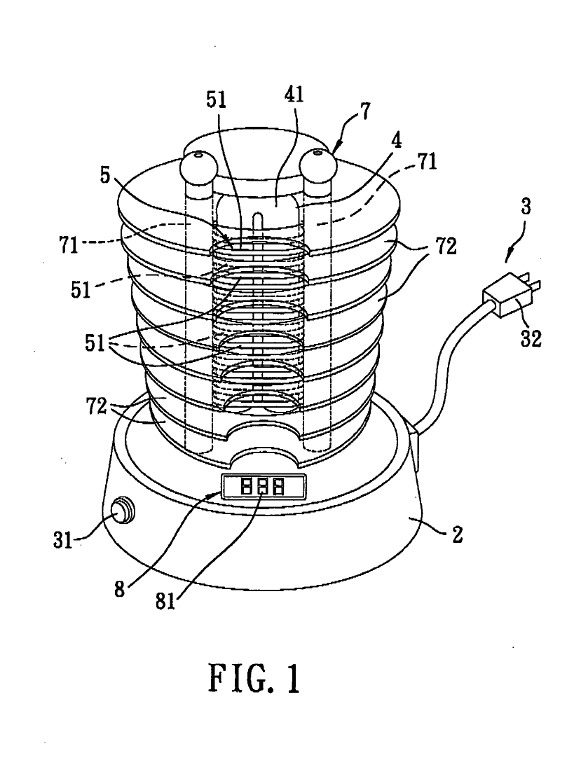

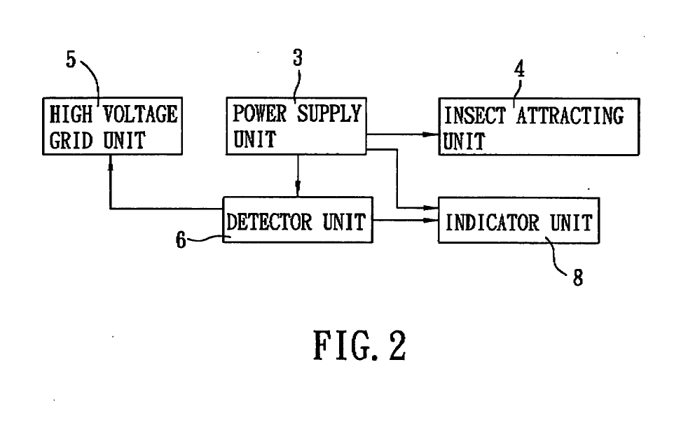

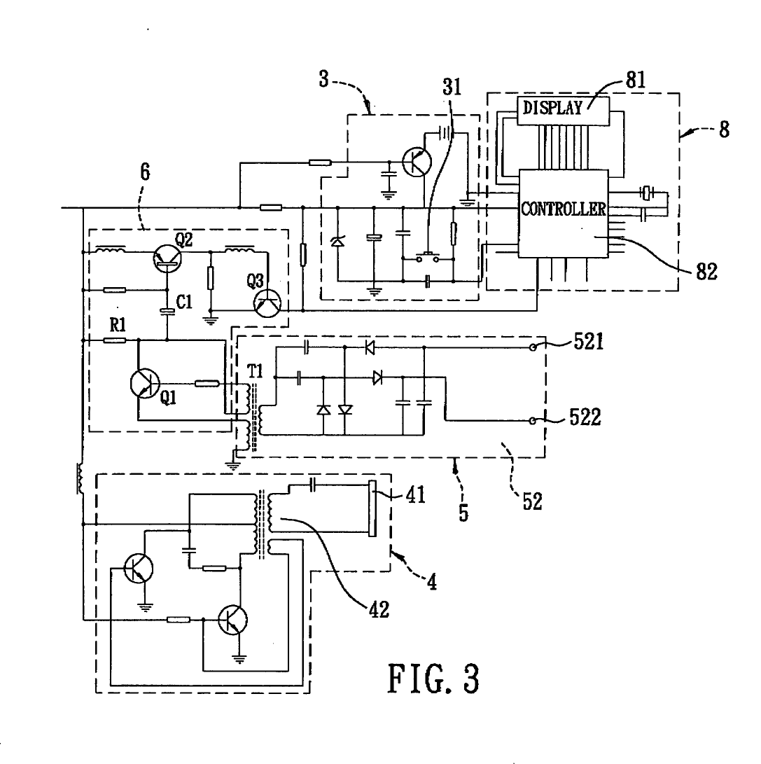

Referring to FIGS. 1 to 3, the preferred embodiment of an electric insect trap according to the present invention is shown to comprise a base 2, a power supply unit 3, an insect attracting unit 4, a high voltage grid unit 5, a detector unit 6, a grille unit 7, and an indicator unit 8.

The power supply unit 3, which includes a power switch 31 mounted on the base 3 and a power source connector 32 extending from the base 2, is operable so as to convert commercial AC power into a DC voltage, such as 6 VDC, that is provided to the various electrical components of the electric insect trap.

The insect attracting unit 4 includes a light source 41 mounted uprightly on the base 2, and drive circuitry 42 disposed in the base 2, coupled to the light source 41, and connected electrically to the power supply unit 3. The light source 41 is operable so as to generate light for attracting flying insects thereto. In this embodiment, the light source 41 is an ultraviolet lamp capable of radiating light within a wavelength range of 355 to 365 nm.

In this embodiment, the high voltage grid unit 5 includes a plurality of conductive annular grid elements 51 and a voltage booster 52 coupled to the grid elements 51 and connected electrically to the power supply unit 3 via the detector unit 6. The grid elements 51 surround the light source 41, are spacedly arranged along the length of the light source 41, and are connected alternately to output terminals 521, 522 of the voltage booster 52. The grid elements 51 in each adjacent pair are spaced apart from each other by a distance sufficient to ensure that an insect can contact the same simultaneously. The voltage booster 52 boosts the DC voltage generated by the power supply unit 3 and received from the detector unit 6 into a sufficiently high voltage, such as 2000 VDC, that is present across the output terminals 521, 522. Therefore, an insect can be electrocuted when it comes into contact with any adjacent pair of the grid elements 51. In other embodiments of this invention, the grid elements 51 can be in the form of slender upright wires that are disposed to surround the light source 41 and that are spaced apart from each other in a circumferential direction with respect to the light source 41.

The detector unit 6 is disposed in the base 2, couples electrically the power supply unit 3 to the high voltage grid unit 5, and is operable so as to detect an insect-electrocuting state of the high-voltage grid unit 5 in a manner to be described hereinafter.

In this embodiment, the grille unit 7 is made from an electrical insulating material, and includes four posts 71 (only two are visible in FIG. 1) mounted uprightly on the base 2, disposed to surround the grid elements 51, and spaced apart from each other in the circumferential direction with respect to the light source 41. The grille unit 7 further includes a plurality of annular partition plates 72 mounted on the posts 71 and spacedly arranged along the length of the light source 41. The partition plates 72 enable insects to reach the grid elements 51 while preventing a human body part from coming into contact with the grid elements 51. In this embodiment, the partition plates 72 are made from a transparent material that enables transmission of the light radiated by the light source 41 therethrough to further enhance the insect-attracting effect.

In this embodiment, the indicator unit 8 includes a display 81 (such as a liquid crystal display) mounted on the base 2, and a controller 82 disposed in the base 2 and coupled electrically to the power supply unit 3, the detector unit 6 and the display 81. The controller 82 receives detector signals from the detector unit 6, and controls the display 81 so as to provide a visual indication of a cumulative number of insects electrocuted by the high voltage grid unit 5.

In use, insects are attracted to the electric insect trap in view of the light generated by the light source 41 of the insect attracting unit 4. When an insect comes into contact with an adjacent pair of the grid elements 51, a short-circuit will be formed between the output terminals 521, 522 of the voltage booster 52, and the insect will be killed by electrocution. The open-circuit state between the output terminals 521, 522 of the voltage booster 52 is restored when the killed insect falls off from the grid elements 51 or is fragmented as a result of the electrocution. In addition, when the output terminals 521, 522 of the voltage booster 52 are short-circuited during electrocution of an insect, a transformer (T1) of the voltage booster 52 changes to a saturated state, thereby resulting in a higher load for a transistor (Q1) of the detector unit 6. In turn, the voltage at a junction of a resistor (R1) and a capacitor (C1) of the detector unit 6 is pulled down to result in interruption of the supply of electric power to the voltage booster 52 for a preset time interval, such as 0.5 second, and in the detector signal that is received by the controller 82 of the indicator unit 8 through transistors (Q2, Q3) of the detector unit 6. In response to the detector signal, the controller 82 updates the cumulative number of electrocuted insects, and controls the display 81 to show the updated cumulative number thereon.

As mentioned hereinabove, the open-circuit state between the output terminals 521, 522 of the voltage booster 52 is restored when the killed insect falls off from the grid elements 51 or is fragmented as a result of the electrocution. Therefore, when the voltage at is the junction of the resistor (R1) and the capacitor (C1) of the detector unit 6 is restored to the normal operating voltage, electric power is once again supplied to the voltage booster 52 to enable operation of the high voltage grid unit 5.

In other embodiments, the information shown on the display 81 may vary according to actual requirements. In addition, control buttons (not shown) may be provided on the base 2 for configuring the controller 82 of the indicator unit 8 with other functions, such as count reset, time set and display, etc.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. An electric insect trap comprising:
a base;
an insect attracting unit provided on said base;
a high voltage grid unit provided on said base and disposed to surround said insect attracting unit;
a detector unit coupled electrically to said high voltage grid unit and operable so as to generate a detector signal corresponding to an insect-electrocuting state of said high voltage grid unit; and
an indicator unit coupled electrically to said detector unit and operable so as to indicate number of insects electrocuted by said high-voltage grid unit based on the detector signal received from said detector unit.

2. The electric insect trap as claimed in claim 1, wherein said detector unit interrupts supply of electric power to said high voltage grid unit for a preset time interval upon detection of the insect-electrocuting state of said high voltage grid unit.

3. The electric insect trap as claimed in claim 1, wherein said indicator unit includes a display mounted on said base, and a controller coupled electrically to said detector unit and said display.

4. The electric insect trap as claimed in claim 1, wherein said insect-attracting unit includes a light source.

5. The electric insect trap as claimed in claim 4, wherein said light source is an ultraviolet lamp that generates light within a wavelength range of 355 to 365 nm.

6. The electric insect trap as claimed in claim 4, wherein said high voltage grid unit includes:
a voltage booster having a pair of output terminals; and
a plurality of annular conductive grid elements that surround said light source, that are spacedly arranged along said light source, and that are connected alternately to said output terminals of said voltage booster.

7. The electric insect trap as claimed in claim 1, further comprising a grille unit provided on said base and disposed to surround said high voltage grid unit.
